(19) United States
(12) Patent Application Publication
(10) Pub. No.: US 2013/0283194 A1
(43) Pub. Date: Oct. 24, 2013

(54) SYSTEMS AND METHODS FOR MANAGING CONTENT USING VIRTUAL CARDS

(71) Applicant: YUDEK, INC., Pasadena, CA (US)

(72) Inventors: David B. Kopp, Pasadena, CA (US); Benjamin S. Waldman, Springfield, VA (US)

(73) Assignee: Yudek, Inc., Pasadena, CA (US)

(21) Appl. No.: 13/866,405

(22) Filed: Apr. 19, 2013

Related U.S. Application Data
(60) Provisional application No. 61/635,731, filed on Apr. 19, 2012.

(51) Int. Cl. G06F 3/0481

(52) U.S. Cl. CPC G06F 3/0481
USPC 715/764

(57) ABSTRACT

A platform for a web-based virtual card collection is disclosed where content related to anything, including but not restricted to subjects, categories, and things, such as entertainment, products, people, ideas, emotions, events, apps, websites, books, food, sports, etc. can be represented as virtual cards. Virtual cards can be created about any subject using platform tools and/or various types of media. Cards can respond to user actions to be flipped and/or flopped in order to reveal and/or provide access to additional content and/or information.

### CROSS-REFERENCE TO RELATED APPLICATIONS

This application claims priority to U.S. Provisional Patent Application 61/635,731, filed on Apr. 19, 2012, the contents of which are incorporated herein by reference in their entirety.

### FIELD

The present invention generally relates to systems and methods for content management based on a virtual cards.

### SUMMARY

The present invention generally relates to systems and methods for managing content through the use of virtual cards which may contain or be associated with various types of media.

In exemplary embodiments, systems and methods for storing and organizing multi-source, multi-format internet based material can comprise one or more processors; one or more non-transitory, computer-readable media containing instructions operable to, when executed by the one or more processors, provide, to a user device associated with a user of a content management system, a graphical interface. In exemplary embodiments, the graphical interface can include one or more interactive virtual cards, at least one interactive virtual deck, and at least one interactive virtual table. In exemplary embodiments, the systems and methods can utilize additional index levels such as “rooms,” which can contain tables and/or “stacks” which can contain cards within decks.

The virtual cards can contain one or more content items with at least one of the content items being displayed on the card via the graphical interface in response to a user card action(s). The virtual deck can contain one or more virtual cards, wherein the one or more of the virtual cards are graphically contained within a deck are displayed on the graphical interface in response to a user deck action. The virtual table may comprise a virtual surface for displaying one or more virtual cards and/or one or more virtual decks in response to a user table action.

### BRIEF DESCRIPTION OF THE DRAWINGS

The objects, features, and advantages of the present disclosure will be more fully understood by reference to the following, detailed description when taken in conjunction with the accompanying figures, wherein:

FIGS. 1A-1F are exemplary depictions of virtual cards according to exemplary embodiments of the present invention;

FIGS. 2A-2D are exemplary representations of virtual cards in various modes according to exemplary embodiments of the present invention;

FIG. 3 is a block diagram of an architecture suitable for implementing the present method and system according to exemplary embodiments of the present invention;

FIGS. 4A-4F are exemplary screenshots related to the creation of virtual cards according to exemplary embodiments of the present invention;

FIGS. 5A-5B are exemplary screenshots related to virtual cards and virtual tables according to exemplary embodiments of the present invention; and

FIGS. 6A-6D are exemplary screenshots according related to searching according to exemplary embodiments of the present invention.

### DETAILED DESCRIPTION

The present invention generally relates to systems and methods for implementing a content management system. The content management system can include a platform that can enable digital content to be managed and/or organized through virtual cards.

In exemplary embodiments, a virtual card can be included and/or be associated with various types of content and/or media. Virtual cards, (or “cards” as used herein) can be created by users and can relate to any subject(s). The cards can be manipulated by users in order to reveal further information and/or content.

In exemplary embodiments, virtual cards can be accessed and/or displayed on a user device, such as a desktop computer, laptop, smartphone, tablet, gaming system etc. Virtual cards can be interactive and/or the card's appearance and/or the associated interface displaying the card can change and/or respond to user actions. For example, virtual cards can display relevant card information, such as, title, author, date created, short description, ratings information/interface, etc. in response to a user action/input such as hovering over the card, or other suitable action.

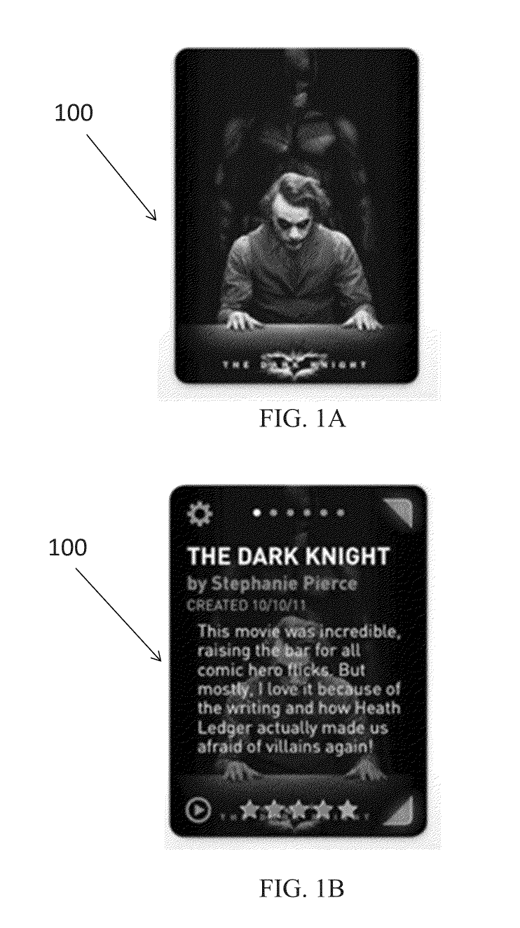

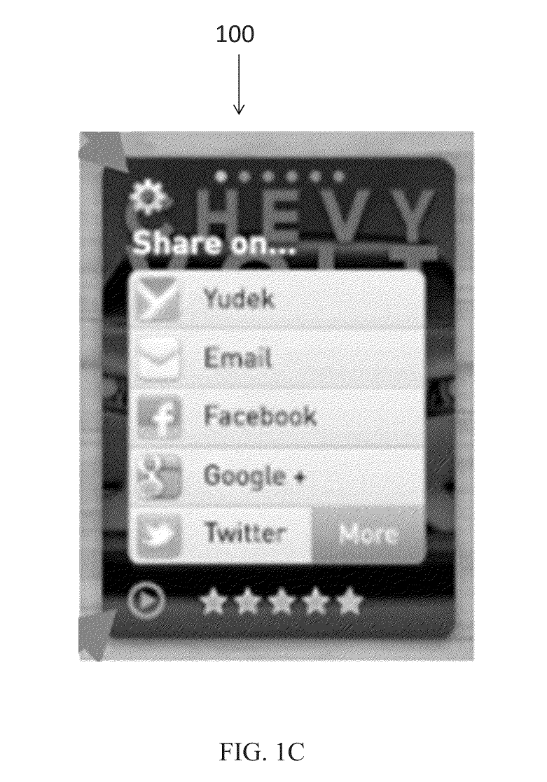

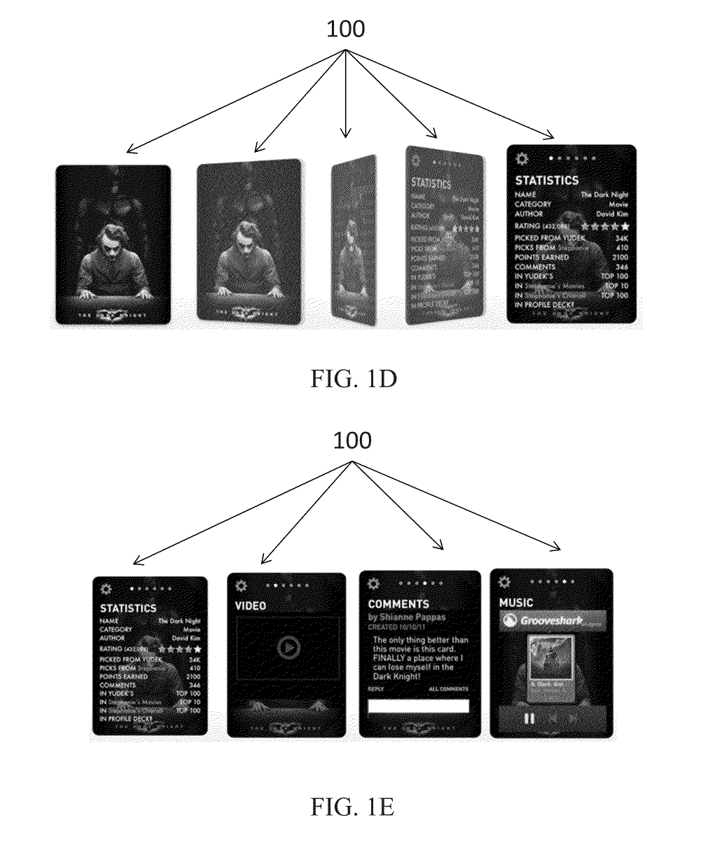

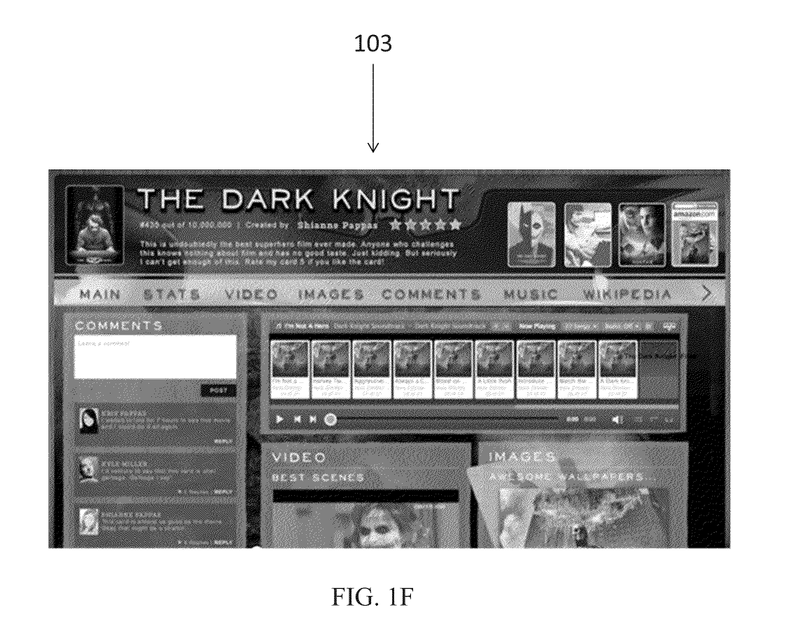

Referring to FIGS. 1A-1E, in exemplary embodiment, various depictions of a virtual card 100 are shown and/or Virtual card 100 can include various content. By way of example, FIG. 1A, shows the card face of particular card 100 which has been created based on the movie “The Dark Knight”. The card face includes a visual or picture associated with the movie.

Referring to FIG. 1B, in exemplary embodiments, the appearance of virtual card ‘100 can change after a user action. Updated virtual card 100 can display informational and/or user selectable elements including, for example, action buttons, ratings buttons and information, description, author, title, etc.

In exemplary embodiments, users can select one or more buttons or other selectable/interactive elements displayed on virtual card 100. Such elements can allow users to share, move, delete, and/or edit virtual cards. In exemplary embodiments, users can select a button and/or element to search or find similar people and/or similar cards on the platform. For example, as shown FIG. 1C, the selection of a button and/or element to share virtual card 100 can present further options to the user, for example, to share the card via the platform (Yudek), email, Facebook, Google+, Twitter, etc.

In exemplary embodiments, users can cause the virtual card to “flip”. This flip action can be accomplished by users selecting and/or clicking on a corner and/or other designated area of the virtual card. The flip action can cause the virtual card to rotate, for example, around a vertical axis. In exemplary embodiments, virtual cards can be flipped and/or rotated in any suitable direction.

Referring to FIG. 1D, in exemplary embodiments, virtual card 100 being “flipped” is depicted. In exemplary embodiments, flipping virtual cards can reveal additional content stored and/or associated with the virtual card. As shown in FIG. 1D, a flip of virtual card 100 can cause the display of a different face of virtual card 100 with statistical and/or other information related to content and/or theme of the virtual card.

In exemplary embodiments, virtual cards can be flipped several times, with at least some of the flips revealing new and/or different content/media related to a theme of the virtual card. For example, each flip can present and/or reveal additional and/or different content e.g., media in the form of text, audio, video, etc.

Referring to FIG. 1E, in exemplary embodiments, various depictions of virtual card 100 after each of a series of flips is shown, where the successively flipped virtual card 100 shows statistical content, video content, comment content, and music content, respectively.

In exemplary embodiments, in addition to supporting a flip action, virtual cards associated with a system 301, described herein, can be capable of being “flopped”. In this regard, after users initiate a flop action with respect to a virtual card, this can cause a user device 30, described herein, to display a different interface. In exemplary embodiments, the interface can allow users to access and/or interact with additional content/media associated with the virtual card. In exemplary embodiments, flop actions can be initiated by users selecting a section of the virtual card presented on the users' device.

Referring to FIG. 1F, in exemplary embodiments, an interface 103 is depicted after flopping a virtual card. The virtual card and/or its graphical representation can be temporarily hidden and/or transformed into a different display. As seen in FIG. 1F, the flop presents a different, typically larger interface 103 than the virtual card. Interface 103 can provide various options and/or access to content relating to the virtual card.

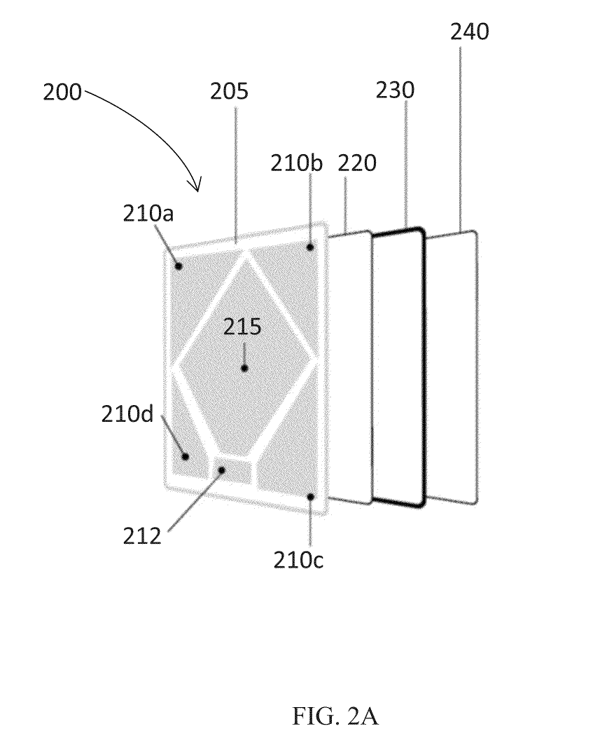

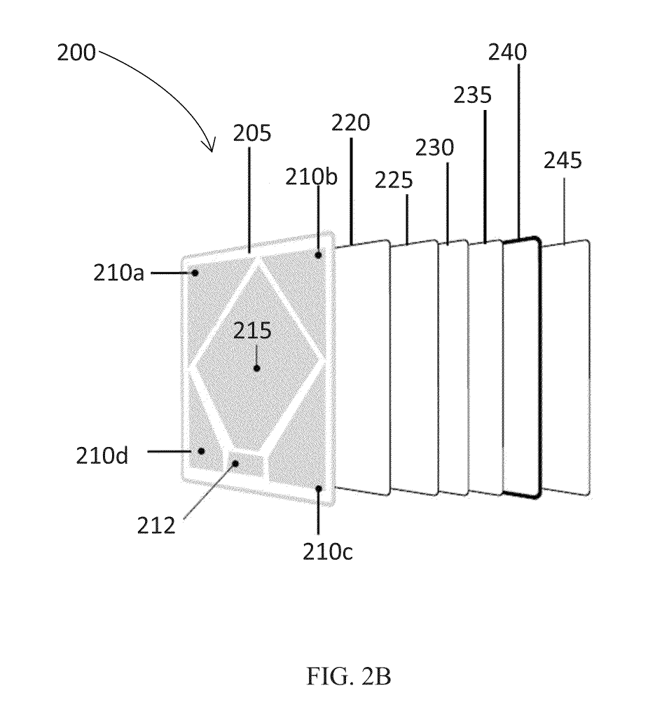

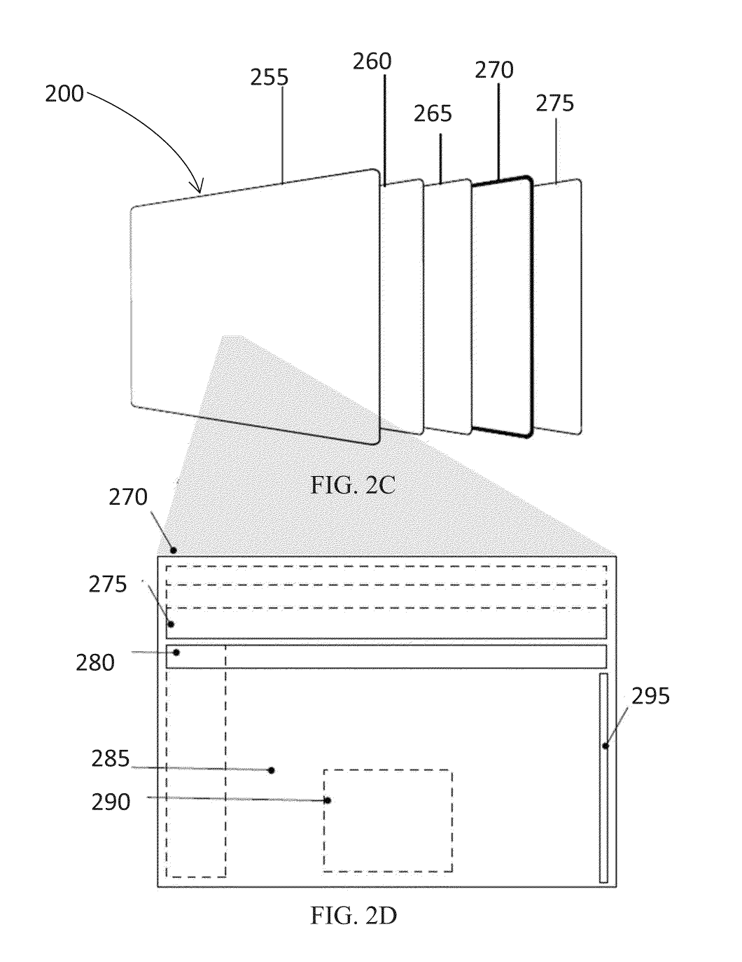

Referring to FIG. 2A-2B, in exemplary embodiments, system 301 can process and/or store information affiliated with virtual cards as a series of one or more layers. Virtual cards can be implemented as being in a flipped mode and/or a flopped mode. In exemplary embodiments, virtual cards can first be presented in a flip mode, regardless of whether it has been flipped yet. In exemplary embodiments, as seen in FIG. 2A, a virtual card 200 can be in a flip mode and can include a clear interaction layer 205, a content layer 220, a media layer 225, a transitory layer 230, a face image layer 235, a perimeter 240, and a backend 245.

In exemplary embodiments, clear interaction layer 205 can be interactive to create a response when a mouse, tap action, etc. is taken on and/or within the boundaries of the clear card. For example, clear layer 205 can include one or more selectable and/or interactive sections/areas. In exemplary embodiments, referring to FIG. 2B, corner areas 210a-210d and/or bottom 212 can each be an interactive/button/hotspot area. In exemplary embodiments, a selection and/or action in such an area (e.g., by touch screen tap, keyboard selection, mouse click, voice command, etc.) can cause system 301 and the virtual card 200 to react. In exemplary embodiments, the selection of the corners can cause virtual card 200 to flip, flop, zoom, display information (e.g., ratings, title, author, information, ratings, etc.) on the clear layer, etc.

In exemplary embodiments, content layer 220 can contain text, web links, icons, objects, frame buttons, and/or other visual information. The content layer can also provide content tools for adding/creating text, links, and providing other objects/elements to the content layer.

In exemplary embodiments, a media layer 225 can include and/or provide media, such as for example, images, audio, video content, and/or other interactive content. Also, a transitory layer 230 can allow users to dim and/or brighten content in one or more layers, such as an image in the face image layer 235.

In exemplary embodiments, face image layer 235 can include one or more images that can be visible to a user. For example, a particular image can be displayed and/or visible to users depending on the current state of the virtual card. For example, when first accessing the virtual card a particular image can be displayed on the face image layer 235. When taking an action, with respect to the virtual card 200, such as a flip, the image can change. In exemplary embodiments, a different image can be displayed each time virtual card 200 is flipped.

In exemplary embodiments, virtual card 200 can include a perimeter 240 that can surround the virtual card 200 and also can be changed and/or be modified in response to user actions, such as selecting a card, hovering over a card, selecting an area of the virtual card etc. For example, the perimeter can change by including a drop shadow, a glow, regular outline, and/or include text, tags, banners, ribbons, stamps, images, etc.

In exemplary embodiments, the virtual card can have other layers, and/or duplicate layers, for example, not shown in FIG. 2A. As shown in FIG. 1A-1F, flipping a virtual card can cause the layers to change and/or be updated. For example, the face image and/or other content stored within the one or more of the layers can be changed and/or updated.

In exemplary embodiments, a backend layer 245 can be a programming layer that can be used by the system 301 and/or an interface using the virtual card. In exemplary embodiments, backend layer 245 can include programming code that can supply and/or collect digital information for and/or from all, or any of, the above layers. In this regard the backend layer can connect to all the layers of card 200 including the interaction layer and/or other intermediary layers. Interactivity with the virtual card can be logged and can be sent to a database. These interactions can include, but are not limited to, activities associated with flipping, rating, liking, flopping, moving the virtual card, trading, buying, playing media, sharing, grabbing/taking, deleting, etc.

Referring to FIG. 2C, in exemplary embodiments, virtual card 200 can be in a flop mode and/or can include a content layer 255, a media layer 260, a flop image layer 265, a perimeter 270, and/or a backend 275. The layers can be similar to the layers of the virtual card when in the flip mode, but may be implemented differently, for example, at least graphically. For example, when in flip mode, as seen in FIGS. 1A-1E, the virtual card can be graphically represented as a card. In flop mode, as seen in FIG. 1F, the virtual card can be represented differently, for example, using a canvas and/or window graphical representation.

Referring to FIG. 2D, in exemplary embodiments, an exemplary representation of a virtual card in flop mode is illustratively depicted. In addition to the aforementioned layers, described in conjunction with FIG. 2C, the flop mode card can contain a header 275, a navigation section 280, a card canvas section 285, one or more modules 290, and/or scroll 295. For example, the content contained in the media layer 260 and/or flop image layer 265 can be represented as modules 290 located/placed against the canvas 285. Additionally content (e.g., modules 290) can be displayed and/or revealed using the scroll bar to navigate canvas 285 and/or by using navigation section 280. Navigation section 280 can receive and/or process URLs or other similar addresses to allow users to navigate to other content associated with the virtual card 200.

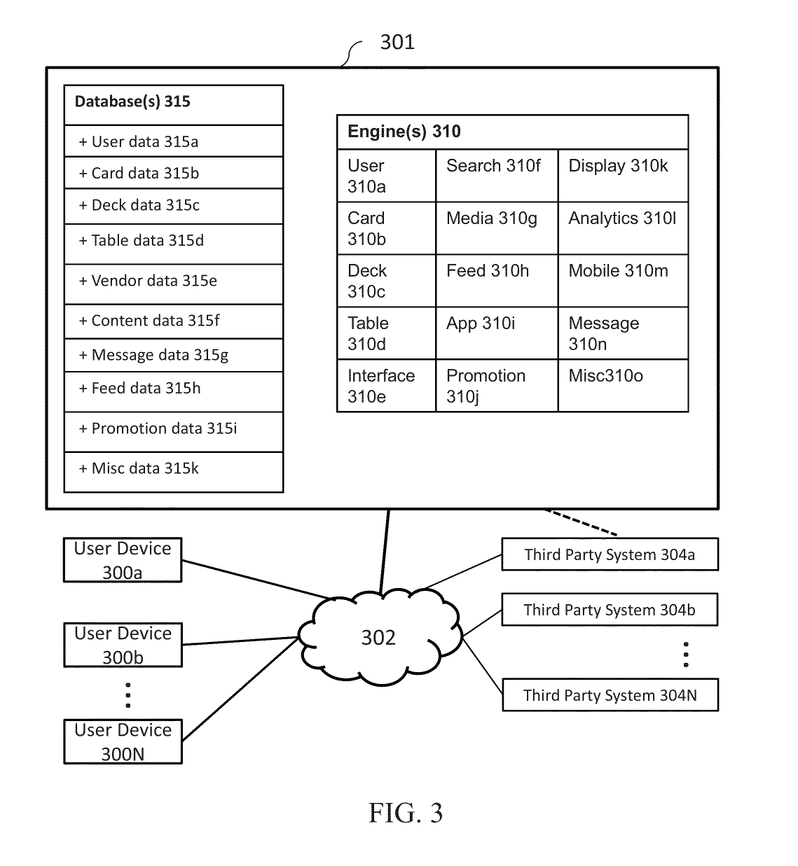

Referring to FIG. 3, in exemplary embodiments, the systems and methods can utilize one or more user devices and/or one or more third party systems. In exemplary embodiments, user devices 300a, 300b, . . . 300N (collectively or individually designated 300) can be any computing device that can operatively connect to system 301. User devices 300 can include devices, such as laptops, desktops, smartphones, tablet devices, and the like, to name a few. User devices 300 can directly or indirectly connect to system 301 through computer network 302. Network 302 can include, for example, the Internet, an intranet, or any other suitable network, via, by way of example, a set of routers and/or networking switches.

System 301 can include devices, such as computers, servers, laptops, desktops, smartphones, tablet devices, and the like, to name a few.

Additionally one or more third party systems 304a, 304b, . . . 304N (collectively third party systems 304) can connect with users devices 300 and/or system 301. Third party systems 304 can include web servers, vendor/advertising networks, information systems, storage/database systems, financial transaction systems, and/or any combination of hardware and/or software needed to implement the embodiments herein.

It will be understood that any of system 301, user devices 300, and/or third party systems 304 can communicate with each other and/or can be further combined and/or separated. For ease, system 301, user devices 300, and/or third party systems 304 are, at times, shown separately. This is merely for ease and is in no way meant to be a limitation.

Further, any element of system 301, user devices 300, and/or third party systems 304 can reside on and/or be affiliated with user devices 300, system 301, third party systems 304. For example, system 301 can reside on and/or be affiliated with third party systems 304. By way of example, system 301 can be an algorithm stored in processor readable memory that can be accessed and/or processed by a processor affiliated with third party systems 304.

As shown, system 301, user devices 300, and/or third party systems 304 can include, but is not limited to, at least one communication portal; at least one graphical user interface; at least one user input; at least one speaker; at least one processor readable memory at least one processor; and any other reasonable components for use in communicating information (e.g., data), storing information, and processing any form of information.

In some instances, the graphical user interface and the user input can be substantially the same. For example, the graphical user interface and the user input can be combined as a touch distribution system. The touch distribution system can be a display that can detect the presence and location of a touch within the distribution system area.

In exemplary embodiments, system 301 can be a content management system responsible for implementing a platform for creating, distributing, managing, virtual cards. In exemplary embodiments, virtual cards themselves can be graphical interfaces for organizing and displaying content to users. The virtual cards can be interactive and respond to user actions, such as mouse clicks, keyboard inputs, touch screen gestures, etc.

In exemplary embodiments, system 301 can provide interfaces for users to access and interact with the virtual cards. The interfaces can include a web browser, an app (such as on a mobile device), a downloadable program, etc. The virtual cards can be stored locally on users devices 300 on system 301 on third party systems, and/or combinations thereof.

In exemplary embodiments, system 301 can include various engines 310 that can provide and/or implement services associated with virtual cards. In exemplary embodiments, the engines 310 can include various processes and/or algorithms and/or can be implemented as software. For example, the engines can be one or more software applications stored on computer readable storage media and can be accessible to other engines, software, computer/processor readable memories, and devices and executed on one or more processors. In exemplary embodiments, engines 310 can be implemented on any suitable computing devices and/or systems. The engines can also include other components, such as, for example, other software and/or hardware. Engines 310 can be implemented on the same computing device and/or one more engines can be implemented on separate computing devices and/or hardware devices which can be operatively connected with each other. The engines can communicate and interface with other devices or third party systems. The engines can be located locally and/or remotely to one or another.

In exemplary embodiments, system 301 can include users engine 310a, a card engine 310b, a deck engine 310c, a table engine 310d, an interface engine 310e, a search engine 310f, a media engine 310g, a feed engine 310h, an application engine 310i, a promotion engine 310j, a display engine 310k, an analytics engine 310l, a mobile engine 310m, a message engine 310n, and/or a miscellaneous engine 310o.

User engine 310a can implement one or more processes related to registering users and/or processing user data and user accounts. Card engine 310b can implement one or more processes related to creating, managing, interacting and/or processing virtual cards. Deck engine 310c can implement one or more processes related to creating, managing, interacting and/or processing virtual decks. Table engine 310c can implement one or more processes related to creating, managing, interacting and/or processing virtual tables.

Interface engine 310e can implement one or more processes related to providing electronic communication capabilities between the system and other computing devices. Search engine 310f can implement one or more processes related to providing searches for content, cards, decks, users, etc. associated with system 301. Media engine 310h can implement one or more processes related to creating, processing, managing, etc. media content. Feed engine 310i can implement one or more processes related to creating, managing, processing, and/or providing feed/update status information regarding cards, decks, tables, users, etc. Application engine 310i can implement one or more processes related to creating, managing, processing, and/or providing applications associated with cards. Promotion engine 310j can implement one or more processes for creating, displaying, and/or managing advertisements and/or promotions.

Display engine 310k can implement one or more processes for causing the display of virtual cards, decks, tables, other content, and/or interfaces. Analytics engine 310i can implement one or more processes for acquiring/compiling statistics and/or providing or determining statistical analyses based on interactions with system 301, cards, decks, tables, users, etc. Mobile engine 310m can implement one or more processes for system 301 interacting with mobile devices.

Message engine 310n can implement one or more processes for facilitating and/or managing the exchange of messages of users of system 301. Messages can be in any form such as text, video, email, etc. using any suitable formats. In exemplary embodiments, messages can be virtual cards. By way of example, when a user communicates a message(s) to other user(s), a relationship card can be generated, where at least some of the media shared between the users (e.g., text, video, music, photos, links, etc.) can be managed in the card, for example, in a manner similar to the same way cards can be managed based on subject. Miscellaneous engine 310o can implement any other processes as needed to carry out embodiments described herein.

In exemplary embodiments, system 301 can include one or more electronic databases, designated by number 315. Database 315 can include one or more sets of data, such as user data 315a, card data 315b, deck data 315c, table data 315d, vendor data 315e, content data 315f, message data 315g, feed data 315h, promotion data 315i, and/or miscellaneous data 315k. In exemplary embodiments, other types of data and/or other databases can be used in conjunction with system 301.

In exemplary embodiments, users data 315a can be any storable and retrievable data containing information related to users who register and/or use system 301. For example, user data 315a can include information identifying users, such as, name, or other identifying information, contact information, and can include information related to cards, decks, tables, created by users, etc. User data 315a can also include additional information related to interactions involving users via system 301. User data 315a can also include information obtained from sources outside the goal system, such as, for example social networks, e.g., Facebook, Linkedln, Twitter, Meetup.com, eHarmony, Google+, to name a few, eCommerce websites, e.g., eBay, Amazon.com, BarnesandNoble.com, to name a few, and other media systems such as email, social media sites, to name a few. User data 315a can include privacy data/settings for determining what information (cards, decks, tables, etc.) can be shared, accessed, and displayed by system 301 and/or users of system 301.

Card data 315b can include storable and/or retrievable information related to virtual cards created stored, and/or processed by system 301. The information can include information regarding the parameters and/or characteristics of the virtual card, including owner, descriptions, layers, media/content, modules contained therein, privacy settings, other card information described herein, etc.

Card data 315b can include storable and/or retrievable information related to virtual cards created stored and/or processed by system 301. The information can include information regarding the parameters and/or characteristics of the virtual card, including owner/creator, descriptions, layers, media/content, modules contained therein, privacy settings, other card information described herein, etc.

Deck data 315c can include storable and/or retrievable information related to virtual decks created, stored, and/or processed by system 301. The information can include information regarding the parameters and/or characteristics of the virtual deck, including owner/creator, descriptions, cards contained therein, placement/location in an interface, privacy settings, other deck information described herein, etc.

Table data 315d can include storable and/or retrievable information related to virtual tables created, stored, and/or processed by system 301. The information can include information regarding the parameters and/or characteristics of the virtual tables, including owner/creator, descriptions, decks and cards contained therein, placement/location in an interface, privacy settings, other table information described herein, etc.

Vendor data 315e can be any storable and/or retrievable data containing information related to vendors (e.g., including users acting on behalf business, organizations, charities, etc.) who register and/or use system 301. For example, vendor data 315a can include information identifying vendor users, such as, by way of example, name, or other identifying information, contact information, and can include information related to cards, decks, tables, created by vendor users, etc.

Content data 315f can be any storable and/or retrievable data containing content (e.g., different types of media), and/or information related to accessing content, stored locally or from various sources outside system 301. Content data 315 can include information indicating, for example, where, what cards, user data and/or any content that is to be used with and/or included with other content information described in embodiments herein, etc.

Message data 315g can be any storable and/or retrievable data information containing and/or that can be related to messages generated and/or sent through system 301. The messages can be text, audio, video, and/or combinations thereof. Message data 315g can identify the sender and recipients and/or other privacy information. Message data 315g data any other message related information in accordance with embodiments herein.

Feed data 315h can be any storable and/or retrievable data information containing related to informational feeds implemented by system 301. The feed data can include data indicating user interactions through system 301, and/or information from third party sources, e.g., Facebook, Twitter, etc. Feed data 315h data can include any other feed related information in accordance with embodiments herein.

Promotion data 315i can be any storable and retrievable data information containing related to promotions, advertisements, etc. implemented by system 301. Promotion data 315i can include information regarding sponsored and/or vendor cards and/or any other promotion/advertisement related information in accordance with embodiments herein.

Miscellaneous data 315k can include any other information needed to implement the various embodiments described herein.

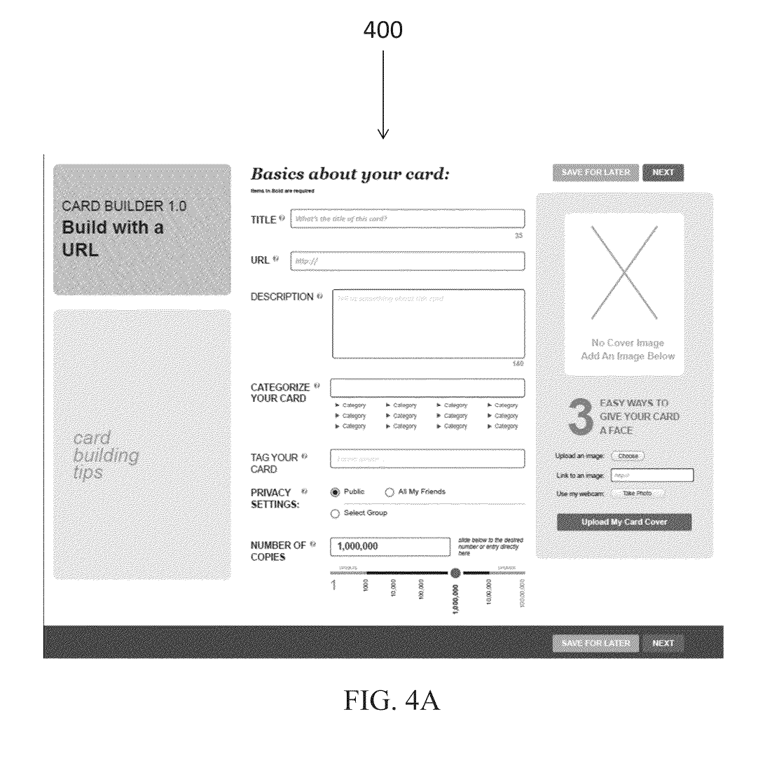

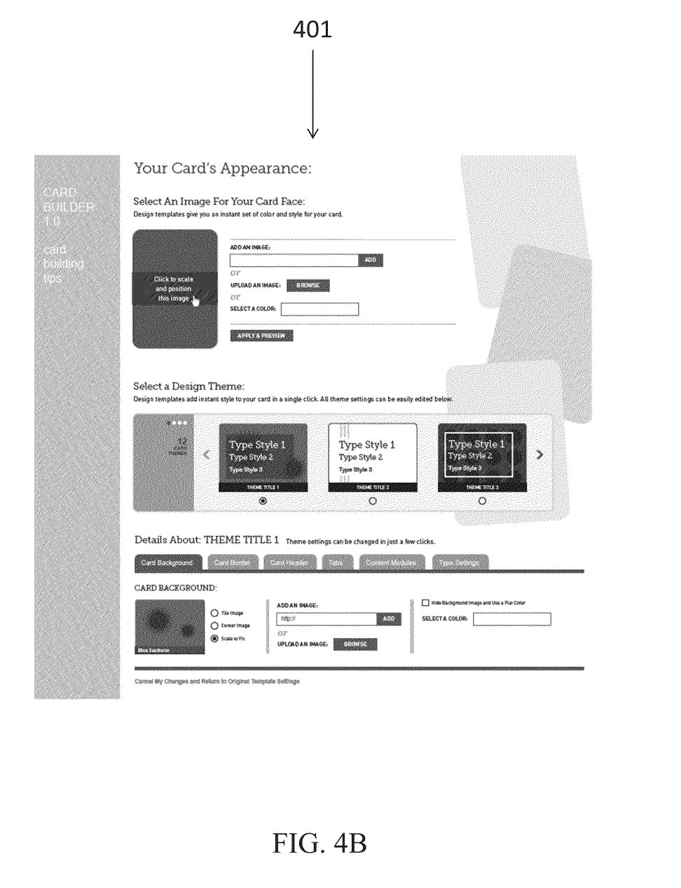

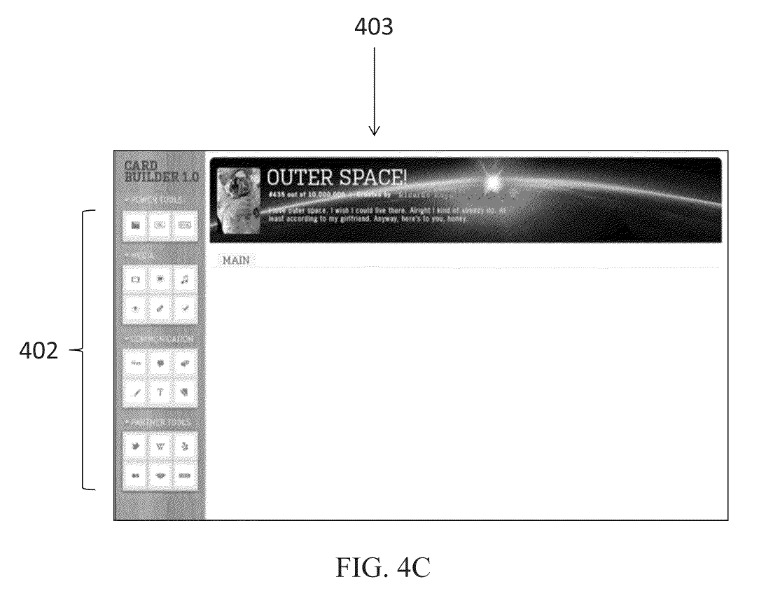

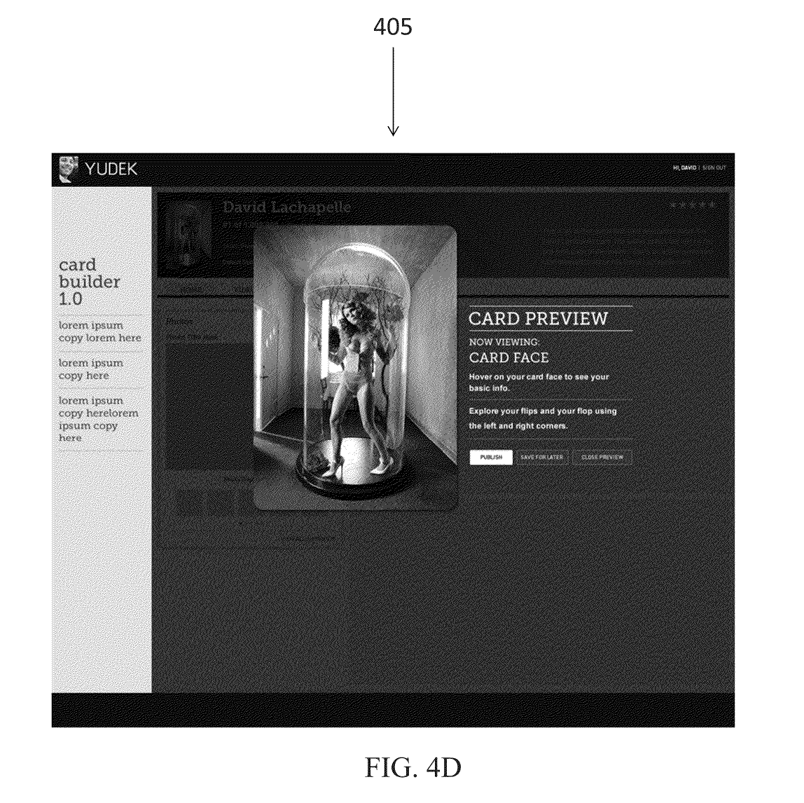

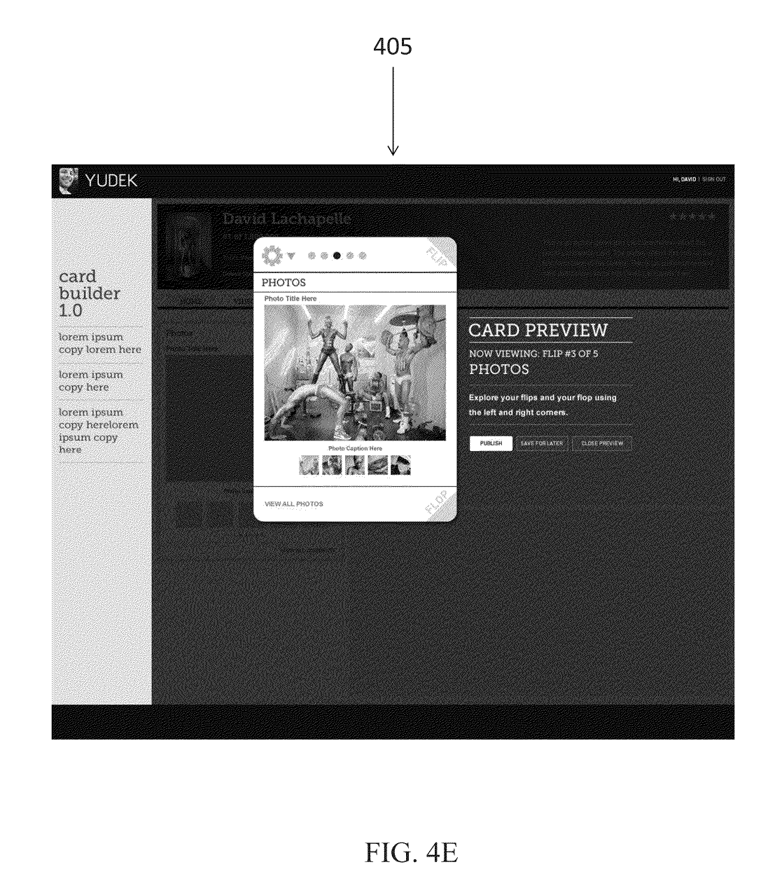

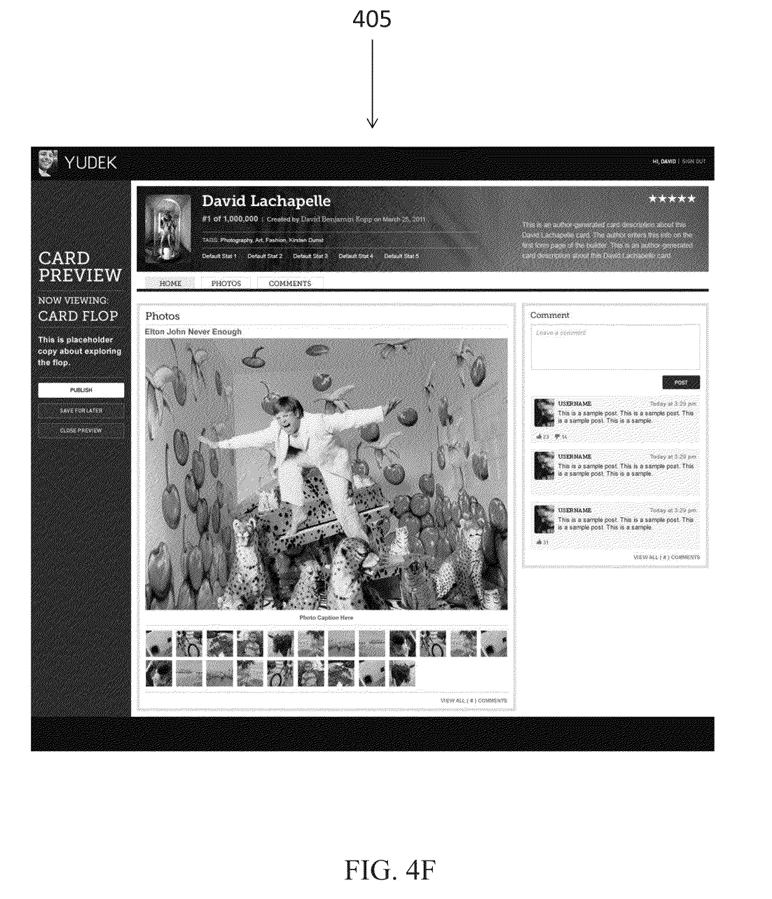

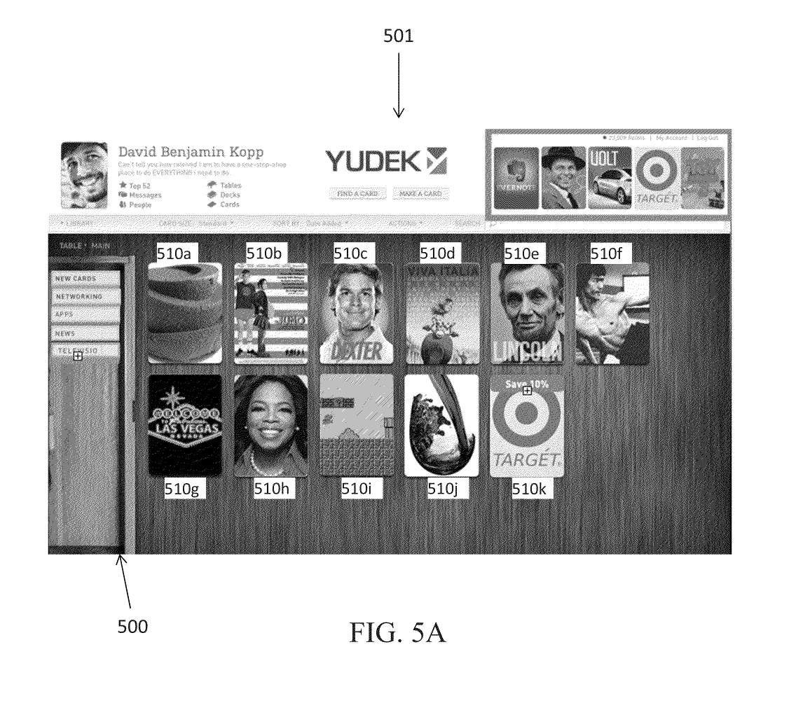

Referring to FIGS. 4A-4C, exemplary screenshots illustrate at least some methods for creating virtual cards according to exemplary embodiments. A user, who may or may not have previously registered with system 301, can create a virtual card through users device 30. System 301 can provide an interface such as a web browser or other suitable means as previously described, for example, to allow users to create virtual cards.

Referring to FIG. 4A, in exemplary embodiment, users devices can be provided with an interface 400 to provide basic information, such as title, description, tags, permissions, public/private status, production information, etc. Further, users can be able to categorize, and add tags to be associated with the virtual card. In exemplary embodiments, users can specify a limit of how many times the virtual card can be published, and therefore shared and/or distributed/copied to other users. For example, users can publish a specified number of cards within a range of 1000 to 10,000,000. In exemplary embodiments, users can be required to pay for the privilege of creating more abundant or scarce cards.

In exemplary embodiments, the interface can provide a button that can allow the generation of a fully populated card (comments, images, video, music) using the information supplied, entered, and/or provided by the user. System 301 can obtain/receive and store information received regarding the in-progress card and store it in database 15. The provided information, as well as any subsequent content/information added or associated with the virtual card, can be stored and/or indexed so that search engine 310f associated with system 301 can be able to provide the created card as a search result in response to a relevant search query.

In exemplary embodiment, for example, referring to FIG. 4B, interface 401 provided to users devices can allow users to design the virtual card. Interface 401 can provide tools and/or options to allow users to design or specify the virtual card's appearance and/or other settings associated with the virtual card. In exemplary embodiments, users can select and/or upload an image for the virtual card's face. Additionally other appearance settings such as colors, titles, themes, etc. can also be specified by the user.

Still referring to FIG. 4B, in exemplary embodiments, a cards appearance can be designed using interface 401. It will be understood that the same interface and/or similar interface can be used for the “flips” of a card. In exemplary embodiments, users can design a card's flips. The same options and/or different interface options can be provided to design the virtual card's flips. For example, in addition to added an image other content can be added with respect to a flip of a card such as audio content, video content, social media content, email content, etc.

In exemplary embodiments, an engine can accept, for example, through an input field, links from the web and/or the engine can interpret the kind of media (e.g., image, sound, video, text, link, etc.) and organize the media in the card according to media type. This can be a fully automatic process and/or a semi-automatic process (e.g., where the use selects the kind of media) that may be used to reduce the customizations necessary for building a card. In exemplary embodiments, card builder models can be used as an API that may be available to users, for example, premium users/vendors to create more dynamic cards such as applications, specialty and/or unique vendor cards, etc.

Referring to FIG. 4C, in exemplary embodiments, after designing the virtual card, users can take actions to “build” the virtual card. For example, a card builder interface 403 can be accessed through users device and can provide modules 402, which can include media players, animations, plug-ins, “widgets,” “apps,” from third-parties, etc. Other modules or tools can include a shopping cart for free, subscriptions and/or one-time fees depending on the user's account status. Other content can be added with respect to a card face, such as audio content, video content, social media content, email content, etc. Some content, such as from a website, (e.g., Wikipedia, Google search result page, etc.), can be added by specifying (e.g., copy and paste, manually enter, etc.) the link in an appropriate field specified in card builder interface 403. In exemplary embodiments, the aesthetics of the virtual card can be adjusted, including the color of the line the outlines the virtual card flop to the look of the tabs, to the placement of the modules. System 301 can allow users to add content via modules. In this regard, the icons associated with the modules (e.g., plug-ins, widgets, etc.) can be dragged onto the virtual card “canvas”. Modules' appearance including font, background color, etc. can also be modified. The media modules can create and/or import media/content (text, pictures, video, feeds, information, etc.) into a card for display or presentation to users.

System 301 can provide a card builder interface that can provide at least the same design and build options not only for the virtual card face, but also for the other layers of the virtual card, e.g., card flip and flop layers. After building a virtual card, system 301 can provide a preview of the virtual card before finalizing and publishing the virtual card for the user. If users is not satisfied with the virtual card, users can edit and/or revise the virtual card.

Referring to FIGS. 4D-4F, exemplary screenshots showing previews of a pending virtual card in interface 405 are illustrated. For example, FIG. 4D shows a screenshot of a preview of the virtual card face. FIG. 4E shows a screenshot of a preview of one of the virtual card flips for the virtual card. FIG. 4F shows a screenshot of a preview of a card flop for the virtual card.

In exemplary embodiments, various types of cards can be created, for example, by different creators for different purposes and/or audiences. System 301 can provide for the creation of a profile card, user card, vendor card, app card, media card, to name a few. Some cards can have templates or predefined properties.

In exemplary embodiments, a profile card, for example, can be created when users sign up and/or register with system 301. A profile card can display a profile picture of users and can include basic information such as birth date, location, etc. Additionally, the virtual card can have status information, statistical information, awards and/or badges, user wishes, etc. Users card, can be any card created by the user, as described herein.

In exemplary embodiments, a vendor card can be created by an authorized user on behalf of an entity, such as a business, charity, and/or other organization. In exemplary embodiments, a host card can be created by users associated and/or authorized by the system.

In exemplary embodiments, an app card can be created by using tools associated and/or provided with system 301, such as an API. App cards can implement certain processes and, in at least some instances, can be more dynamic than other cards. In exemplary embodiments, cards can be available for purchase, such as from a media store associated with system 301.

In exemplary embodiments, a media card can include and/or host traditional media such as, books, songs, albums, video, television programs, films, etc. The content of media cards can have restrictions, including being locked, and/or having content that may not be accessible until users makes some further action (e.g., payment or other consideration, etc.). Users can unlock and/or obtain access to the content by paying for a license to the content, and/or any other suitable action. In exemplary embodiments, users can choose and/or specify the form and/or type of media they wish to access. For example, users can have the option to pay one amount to stream video and another amount (e.g., a larger amount) to download a hard copy version of the content.

In exemplary embodiments, virtual cards can offer content at least as flexible as what “user” cards offer. For example, each media card can host an area to comment and/or start a discussion in the discussion forum. In exemplary embodiments, cards can allow users to add customized own tabs and/or modules in order to customize the virtual card.

In exemplary embodiments, cards, such as media cards, can be available for download and/or purchase from a media store, card store, store, etc. operated and/or affiliated with system 301. Further, cards can also be suggested to users who interface with system 301, and/or can be returned as search results.

In exemplary embodiments, users can collect cards through the creation of cards, the taking of cards, and/or through the raking of cards. User can make cards according to at least previous described embodiments herein. User can also “take” card, through an interface provided by system 301, select a card from other users, search results, promoted cards, etc. and the virtual card can be added to the user's selection. Users can add a card to particular deck, table, drawer, etc.

In exemplary embodiments, users can also rake cards. For example, system 301 can be able to add a card from another outside system 301 (e.g., outside an interface provided by system 301). In exemplary embodiments, system 301 can provide a tool, for example, either as an add-on/plug-in, etc. to a browser and/or as a link included on a website. In this regard, users can navigate to a site and select the tool (either from the browser or from the website). The selection can cause the creation of a card with the site. System 301 can pull and/or retrieve content associated with the site, e.g., the content form specific link and/or other links from the same domain so to create a virtual card. The site card can then be added to the user's and/or other users' card collections.

System 301 can allow for virtual cards, which can promote business, events, etc. For example, promotions cards can be created by and/or on behalf of companies. The virtual cards can be distributed by companies, such as through a company facility (e.g., checkout register) and/or through direct mail or email campaigns. By way of example, music bands could offer VIP cards to their fans at concerts with exclusive audio and video coverage. In exemplary embodiments, physical cards based on virtual cards can be printed and distributed that may, for example, carry the Yudek Inc. logo, other various pertinent information such as the QR code mentioned below, and/or any other information. Further, physical cards can have a QR code and/or other information that can be used to direct users to the virtual card.

Similarly, cards can contain a code, such as a QR code, bar code, etc. Users can display the code, such as on a mobile app on a mobile device (e.g., smartphone), to a code scanner/reader device to scan. The information can be used in conjunctions with other devices (e.g., check out registers, etc.) to trigger deals and/or delivery to other websites.

In exemplary embodiments, virtual cards can display logos insignias, other unique features/elements to distinguish cards from one another. Further, cards can have certain unique features such as corner radius, card stock, finish, etc. Various features can be used to distinguish and/or mark cards as “official” cards for a business, organization, individual (e.g., celebrity, sports figure) and prevent and/or discourage the creation of fake and/or counterfeit cards. System 301 can include virtual (e.g., invisible, watermarking, etc.) markings to track authentic cards and non-authentic cards.

In exemplary embodiments, system 301 can provide organizational elements and/or tools for managing virtual cards that can be accessed by users through an interface provide by system 301. Organizational elements can include virtual tables, drawers, decks, etc. in addition to the virtual cards. Organizational elements can be implemented in a hierarchal and/or directory type scheme.

In exemplary embodiments, a virtual table can be implemented as graphical interface appearing as table, against which cards can be seen and/or can be navigated through. A virtual table and/or “table” can be particular and/or contained within one or more “places”, such as locations within a graphical interface provided to users device 300 by system 301. The table can be a background of a user interface of a user device and virtual cards can be located in any configuration for viewing in the interface. Virtual cards can be interacted with and/or navigated through, for example, enabling users to scroll through a plurality of virtual cards. By way of example, users can advance forward and/or backward through various virtual cards and/or information affiliated with the virtual cards. Further, as disclosed herein, virtual cards can be shared and/or deleted, for example, by users. For example, virtual cards can be shared on any third-party services, such as Gmail, Twitter, Facebook, Yahoo!, Linkedln, and Google+. Other services such as, email, social media, etc.

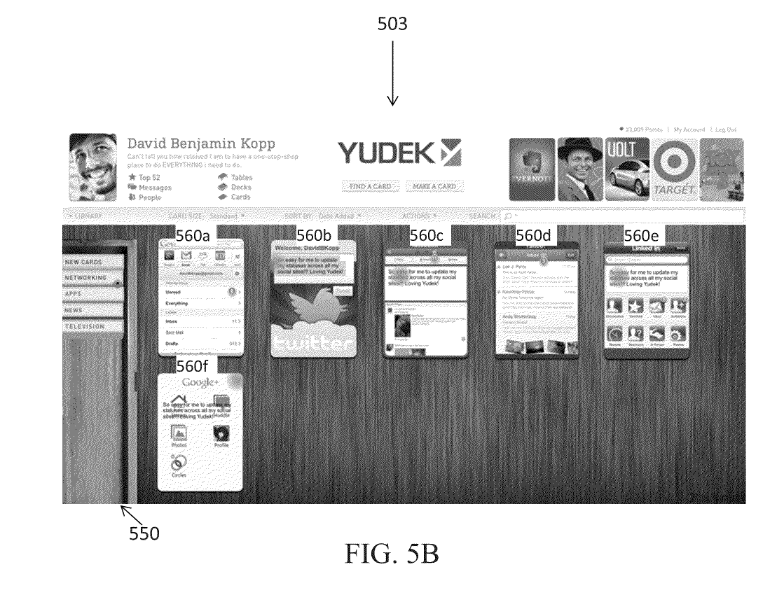

Referring to FIGS. 5A and 5B, in exemplary embodiments, tables 500 can be displayed in an interface 501. For example, FIG. 5A shows a table 500 containing, a plurality of virtual cards, 510a-510k. These cards displayed on table 500 can be media cards having various forms of content related to, for example, movies, TV shows, celebrities, locations, video games, department stores, etc. System 301 can allow multiple tables for a user. Similar types cards can be located and/or can be grouped (e.g., manually and/or automatically by system 301) on a particular table. Referring to FIG. 5B, an exemplary table 550 displayed in interface 503 is depicted containing virtual cards 560a-560f. Cards 560a-560f can include content that can be retrieved from third-party services, such as Gmail, Twitter, Facebook, Yahoo!, Linkedln, and Google+. Other services such as, email, social media, etc. can be used to feed content to cards.

In exemplary embodiments, a virtual table presented in a graphical interface can be moved and/or another area can appear “beneath” the table which can contain a carousel of all the user's tables. By way of example, tables can be interacted with, for example, using actions, such as clicking on a “table” icon to reveal tables or clicking on a “library” icon/element to reveal a window containing the user's entire account in the form of a standard directory. In exemplary embodiments, all of a user's tables can be seen by clicking the “table” icon users to reveal all the tables in the area where tables exist, such as the middle area of the browser. In exemplary embodiments, users can click on the “library” icon to reveal a window containing the user's entire account in the form of a standard directory.

In exemplary embodiments, virtual tables can include one or more drawers on an edge. The drawers can be “opened” by a user, for example, clicking and/or dragging the graphical representation of the drawer in the interface. By opening the drawer, users can obtain access the user's virtual decks.

In exemplary embodiments, users can create and/or system 301 can provide feed tables and/or areas. A feed table can be similar to other tables and/or can include cards which can show status updates regarding other users and/or the other user's interactions with system 301. In exemplary embodiments, the feed table can include cards indicating what other users are sharing, posting, adding to their collections, and/or other suitable interactions. For example, system 301 can provide an interface showing a default view of the feeds table where “all” of your feeds can be displayed, for example, stacked in vertical and/or horizontal tracks. For example, system 301 can provide a feed that visually moves across the interface from left to right with the most recent cards appearing on the left. It will be understood that the feed can move in any direction, for example, right to left, left to right, up and down, spiral, etc. The feeds provided by system 301 can be updated periodically, upon request from a user, and/or updated in real-time. Users can specify a feed and/or feed table to be limited to a certain users, e.g., friends, family, acquaintances, etc.

In exemplary embodiments, virtual decks can be a collection of virtual cards grouped together. Users can create decks in a manner similar to the creation of virtual cards. For example, users can create virtual decks with specified names, colors, designs, etc. Users can select a particular deck and under take other actions to cause the virtual cards contained therein to be displayed on users device.

In exemplary embodiments, decks can be implemented and/or created through system 301, including a networking deck, a junk deck, a top deck, a promote deck, to name a few. For example, a networking deck can be created completely originally without guidance and/or through a guided process, for example, during the sign up/registration. The networking deck can contain cards related to a user's social networking profiles accounts (e.g., Facebook, LinkedIn, Tumblr, Yelp, YouTube, Google+, etc.), email accounts (e.g., Gmail, Yahoo! Mail, etc.), and the like, to name a few. Cards can include functionality to access, retrieve, and/or display content from such accounts and services.

In exemplary embodiments, a deck can be a junk deck. For example, when users delete a card, system 301 may not permanently delete and/or erase the virtual card and/or its contents instead system 301 can “move” deleted cards to a junk deck. Users can permanently delete cards from their junk deck, but the virtual cards may be held in the junk deck, permanently or for a period of time in event the users wish to find and/or retrieve a previously deleted card.

In exemplary embodiments, decks can be offered by system 301 using a TOP 52 deck. A TOP 52 deck can allow users to collect 52 cards or less, which can be displayed when accessing a user's profile. In exemplary embodiments, the Top 52 deck can be displayed and/or hosted on the user's main table and/or can be mirrored in the user's profile card. For example, a user's Top 52 deck can be accessible through a link displayed in an interface provided by system 301 to user devices 30, such as in the top area of a page. In exemplary embodiments, TOP 52 deck can include any suitable number of cards such as 5, 10, 15, 18, etc.

System 301 can provide and/or allow for promoted decks. In exemplary embodiments, promoted decks can contain one or more cards associated with vendors, users, and/or other entities. Promoted decks can be displayed in search results.

In exemplary embodiments, system 301 can allow users to specify whether cards, tables, decks, etc. can be shared publicly, kept private (visible to the card's user but locked or invisible to others, or select groups), shared with a specified group and/or made invisible to other users.

In exemplary embodiments, system 301 can provide various services and/or functionalities to allow users to communicate. In exemplary embodiments, system 301 can provide users with the ability to message other users. The messaging service can be implemented using virtual cards. For example, the act of messaging someone on system 301 can cause a custom card to be created and/or shared between the sending user and the recipient user. This “message card” can support messages (text-like messages, email messages, instant messages, video messages, audio messages, etc.) between the users.

In exemplary embodiments, message cards can support the addition of content and/or modules. For example, modules providing news feeds, social media data/feeds, etc. can also be added to message cards for a pair (or more) of users. Messages cards can include tabs. Tabs can allow users to easily navigate between images, video, other types of files, etc. added to message cards shared between users. Tabs can be automatically generated by system 301 and/or system 301 can allow users to generate custom tabs for the messaging card. For messages sent to multiple users (e.g., group messaging), a message card can generated and all recipients of the message can be subscribers with access to the generated message card. In exemplary embodiments, users can specify who has access to a message card.

In exemplary embodiments, system 301 can provide a search functionalities such as a search engine which can be accessible to users. The search engine can allow users to submit queries to search for users, cards, tables, decks, etc. The interface can allow users to view the search results in different manners, such as, in grid format, in list format, and/or any other suitable means.

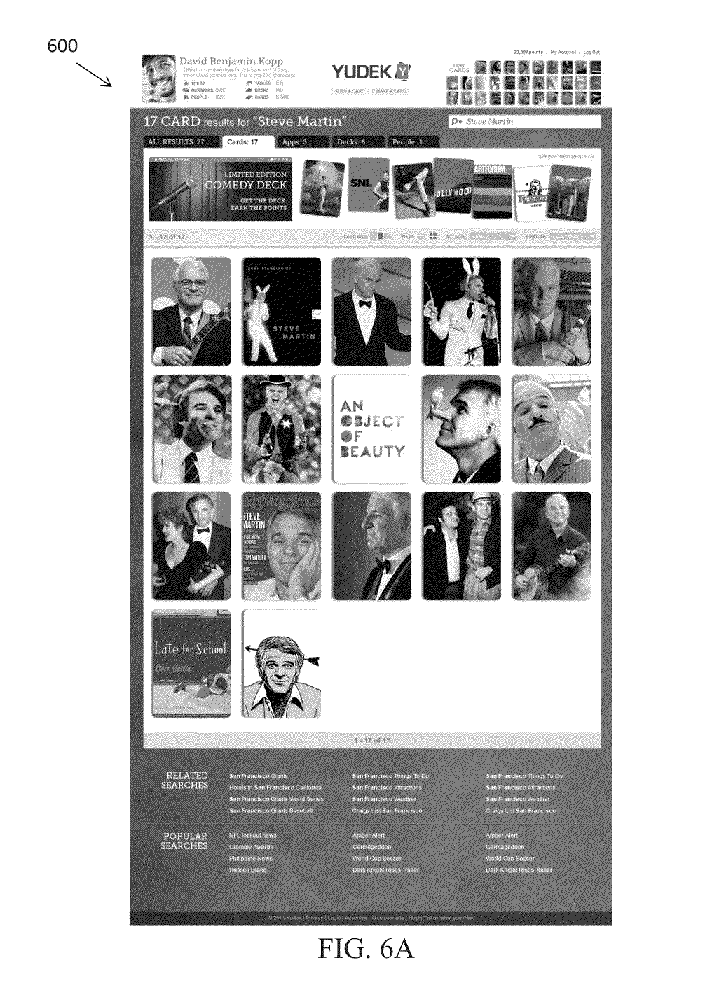

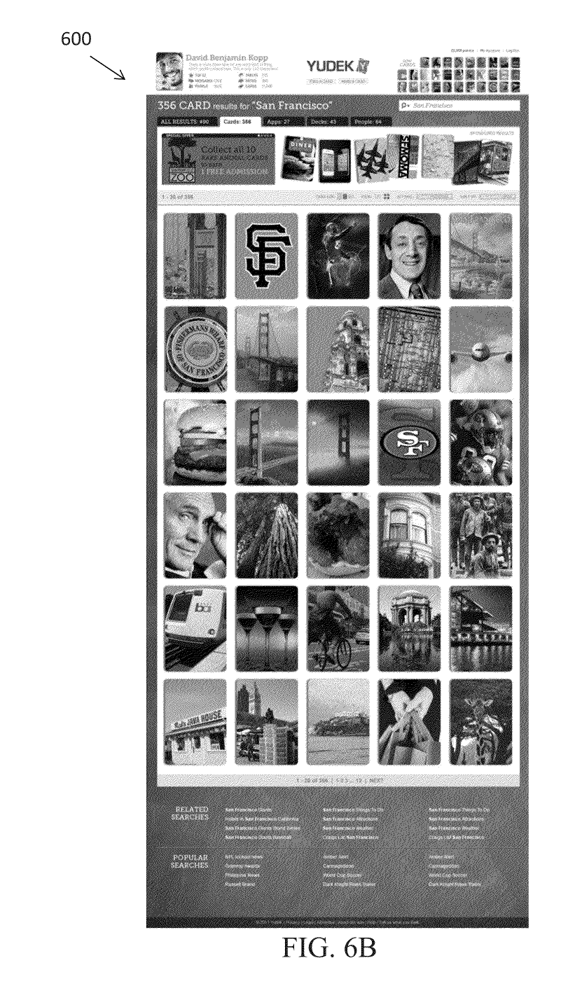

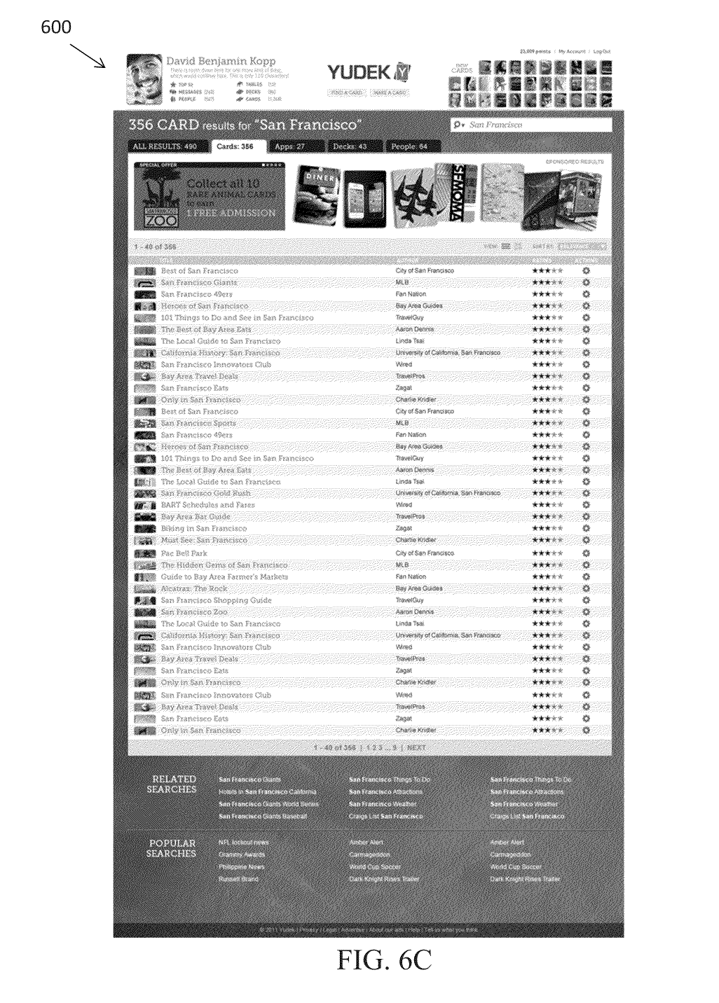

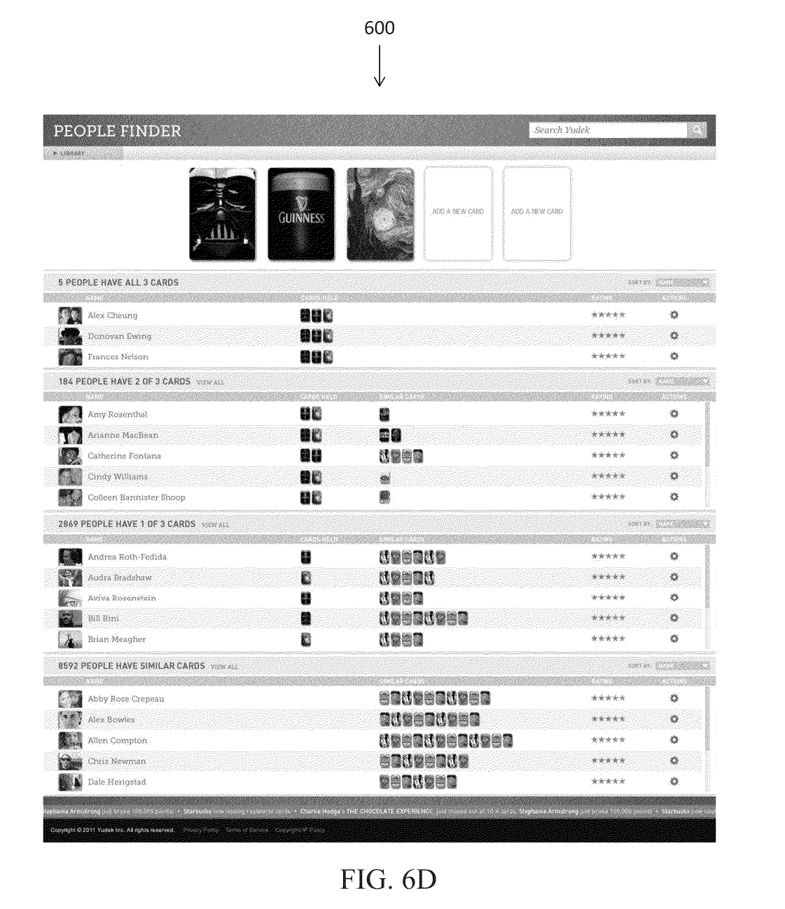

Referring to FIGS. 6A-6D, exemplary embodiments of system 301 providing search results to users in interface 600 are illustrated. For example, FIGS. 6A-B show search results provided by system 301 in grid form. Referring to FIG. 6A, interface 600 displays cards returned from system 301 in response to a search query for “Steve Martin”. Referring to FIG. 6B, interface 600 displays cards returned from system 301 in response to a search query “San Francisco”. Referring to FIG. 6C, interface 600 displays results to the search query “San Francisco” in list format.

In exemplary embodiments, users can search for things other than cards, such as people, locations, goods, etc. Referring to FIG. 6D, interface 600 displays cards returned from system 301 in response to a people search query”. The search results can indicate the people relevant to the search query and/or other information related to the search results, e.g., cards held, ratings information, etc.

Search results returned by system 301 can be selectable by users through the interface on which they are provided. The search results and/or selections of search results can be saved by the user.

In exemplary embodiments, user actions can be tracked and/or recorded regarding interactions occurring through within system 301. For example, system 301 can keep track of user actions such as hovering over a card, flipping a card, flopping a card, engaging cards in a suggestion zone, creating cards, to name a few. Users can receive and/or earn points based on their actions. The points can be used to “buy” and/or access other content items such as cards.

In exemplary embodiments, users can create and/or join groups that allow for the inclusion and/or exclusion of activity. Users can be able to follow each other, for example, by taking, picking, buying, etc. any cards, decks, tables and/or any other element and/or directory level object.

In exemplary embodiments, interfaces can include an activity feed that can function as an area showing users at least some of the activity they have had on cards and/or their activity. have had.

In exemplary embodiments, cards can be any shape, such as, but not limited to, rectangular, square, circular, trapezoidal, to name a few. Further the edges can be rounded, non-rounded, fanciful, etc.

In exemplary embodiments, searches disclosed can include search filters such as, but not limited to, rating, date added, most active, modified, and/or any other filter and/or criteria. In exemplary embodiments, a multi-search feature can be used to allow users to select multiple cards and/or can return results including, but not limited to, other cards, which may relate to the searched cards and/or users who may possess the same and/or similar cards, etc.

In exemplary embodiments, cards can be presented in varying sizes ranging from extra small (“icon”) to extra large and/or cards can be viewed as a list view, detailed view, etc.

In exemplary embodiments, cards can be used as advertisements on other sites. In exemplary embodiments, cards can appear as thumbnail images and/or interactive objects when appearing in other search engines such as Yahoo! and Google and feeds on other sites like Google+, Facebook, Twitter, etc.

It will be understood that any of the steps described can be rearranged, separated, and/or combined without deviated from the scope of the invention. For ease, steps are, at times, presented sequentially. This is merely for ease and is in no way meant to be a limitation.

Further, it will be understood that any of the elements and/or exemplary embodiments of the invention described can be rearranged, separated, and/or combined without deviated from the scope of the invention. For ease, various elements are described, at times, separately. This is merely for ease and is in no way meant to be a limitation.

While the various steps, elements, and/or exemplary embodiments of the invention have been outlined above, it is evident that many alternatives, modifications and variations will be apparent to those skilled in the art. The various steps, elements, and/or exemplary embodiments of the invention, as set forth above, are intended to be illustrative, not limiting. Various changes may be made without departing from the spirit and scope of the invention. Accordingly, the spirit and scope of the present invention is to be construed broadly and limited only by the appended claims and not by the foregoing specification.

What is claimed:

1. A system for storing and organizing multi-source, multi-format internet based material, comprising:
one or more processors;
one or more non-transitory, computer-readable media containing instructions operable to, when executed by the one or more processors:
provide, to a user device associated with a user of a content management system, a graphical interface, the graphical interface including one or more interactive virtual cards, at least one interactive virtual deck, and at least interactive virtual table,
wherein each of the virtual cards contain one or more content items with at least one of the content items displayed on the card via the graphical interface in response to a user card action;
wherein the virtual deck contains one or more cards, wherein the one or more of the virtual cards are graphically contained within a deck and are displayed on the graphical interface in response to a user deck action; and
wherein the virtual table comprises a virtual surface for displaying one or more virtual cards and/or one or more virtual decks in response to a user table action.
